(19) United States
(12) Patent Application Publication
(10) Pub. No.: US 2025/0345723 A1
(43) Pub. Date: Nov. 13, 2025

(54) METHOD AND SYSTEM FOR EXTRACTING MATERIAL USING SUPERCRITICAL FLUID

(71) Applicants: Evan Steiner, Erie, CO (US); Kelly Knutson, Lafayette, CO (US); The Regents of the University of Colorado, a body corporate, Denver, CO (US)

(72) Inventors: Blaise Fleury, Boulder, CO (US); Vladyslav Cherpak, Westminster, CO (US); Jan Bart ten Hove, Boulder, CO (US); Ivan I. Smalyukh, Boulder, CO (US); Evan Steiner, Erie, CO (US); Kelly Knutson, Lafayette, CO (US)

(21) Appl. No.: 19/274,278

(22) Filed: Jul. 18, 2025

Related U.S. Application Data
(63) Continuation of application No. 17/842,487, filed on Jun. 16, 2022, now abandoned.
(60) Provisional application No. 63/211,455, filed on Jun. 16, 2021.

(51) Int. Cl. B01D 11/02

(52) U.S. Cl. CPC B01D 11/0203; B01D 11/0284

(57) ABSTRACT

A method and system of using a supercritical fluid are disclosed. Exemplary methods include using temperature and pressure variation (e.g., above or below supercritical conditions) to remove material from a substrate to form separated and to cause movement of fluid within the system.

### CROSS-REFERENCE TO RELATED APPLICATION

This application is a continuation of U.S. application Ser. No. 17/842,487, filed Jun. 16, 2022, and titled METHOD AND SYSTEM FOR EXTRACTING MATERIAL USING SUPERCRITICAL FLUID, which claims the benefit of U.S. Provisional Application Ser. No. 63/211,455, filed Jun. 16, 2021, and titled METHOD AND SYSTEM FOR EXTRACTING MATERIAL USING SUPERCRITICAL FLUID, the contents of which are hereby incorporated herein by reference.

### FIELD OF DISCLOSURE

The disclosure generally relates to extraction techniques. More particularly, the disclosure relates to supercritical fluid extraction systems and methods.

### BACKGROUND OF THE DISCLOSURE

Extraction techniques can be used for a variety of applications, including cleaning, such as dry cleaning; extracting materials, such compounds from botanicals, such as plants, seeds, flowers, vegetables, or bark; and drying of porous materials, such as aerogels and composite aerogels.

Typical extraction techniques employ mechanical pumps to move fluid (e.g., an extractant or a mixture of an extract and an extractant between various operational vessels. Although such techniques can work relatively well for some applications, traditional extraction system and methods are relatively noisy and can be prone to wear of mechanical parts. Accordingly, improved methods and systems are desired.

Any discussion, including discussion of problems and solutions, set forth in this section has been included in this disclosure solely for the purpose of providing a context for the present disclosure. Such discussion should not be taken as an admission that any or all of the information was known at the time the invention was made or otherwise constitutes prior art.

### SUMMARY OF DISCLOSURE

Various embodiments of the present disclosure relate to methods of using supercritical fluids. While the ways in which embodiments of the disclosure address the shortcomings of traditional methods of using supercritical fluids are discussed in more detail below, in general, embodiments of the disclosure provide methods and systems that can operate relatively quietly and/or that are less prone to mechanical wear of system parts.

In accordance with examples of the disclosure, a method of using a supercritical fluid includes providing a substrate within a first vessel, providing a fluid within the first vessel, forming a supercritical phase of the fluid within the first vessel, removing material from the substrate using the supercritical phase of the fluid, flowing a mixture of the fluid and the material to a separation vessel, reducing one or more of the temperature and the pressure within the separation vessel to below a critical point for the fluid to separate extracted material from the fluid within the separation vessel, collecting the separated material in a collection vessel, and increasing pressure in the separation vessel to cause the fluid within the collection vessel to flow to the first vessel. In accordance with various aspects of these embodiments, the method is performed without a mechanical pump. Rather, the method can use heating and cooling of the fluid to cause circulation of the fluid.

In accordance with further examples of the disclosure, a system for using a supercritical fluid is provided. Exemplary systems include a first vessel comprising a first inlet port to receive a fluid and a first outlet port to expel the fluid, a first inlet valve fluidly coupled to the first inlet port, a first outlet valve fluidly coupled to the first outlet port, and a separation vessel to receive a mixture from the first vessel. In accordance with aspects of the exemplary systems, the separation vessel is further configured to separate the fluid from extracted material, and to increase a pressure within the separation vessel to a pressure greater than a pressure in the first vessel. The separation vessel can include or be coupled to a heater and/or a cooling device. Exemplary systems can include one or more secondary devices to allow continuous operation of the system.

These and other embodiments will become readily apparent to those skilled in the art from the following detailed description of certain embodiments having reference to the attached figures; the invention not being limited to any particular embodiment(s) disclosed.

### BRIEF DESCRIPTION OF THE DRAWING FIGURES

A more complete understanding of exemplary embodiments of the present disclosure can be derived by referring to the detailed description and claims when considered in connection with the following illustrative figures.

FIG. 1 illustrates a system in accordance with examples of the disclosure.

FIG. 2 illustrates another system in accordance with embodiments of the disclosure.

It will be appreciated that elements in the figures are illustrated for simplicity and clarity and have not necessarily been drawn to scale. For example, the dimensions of some of the elements in the figures may be exaggerated relative to other elements to help improve understanding of illustrated embodiments of the present disclosure.

### Detailed Description of Exemplary Embodiments of the Disclosure

The description of exemplary embodiments provided below is merely exemplary and is intended for purposes of illustration only; the following description is not intended to limit the scope of the disclosure or the claims. Moreover, recitation of multiple embodiments having stated features is not intended to exclude other embodiments having additional features or other embodiments incorporating different combinations of the stated features.

In this disclosure, the term gas may include material that is a gas at normal temperature and pressure, a vaporized solid and/or a vaporized liquid, and may be constituted by a single gas or a mixture of gases, depending on the context. Further, in this disclosure, any two numbers of a variable can constitute a workable range of the variable, and any ranges indicated may include or exclude the endpoints. Additionally, any values of variables indicated (regardless of whether they are indicated with about or not) may refer to precise values or approximate values and include equivalents, and may refer to average, median, representative, majority, etc. in some embodiments. Further, in this disclosure, the terms including, constituted by and having can refer independently to typically or broadly comprising, comprising, consisting essentially of, or consisting of in some embodiments. In accordance with aspects of the disclosure, any defined meanings of terms do not necessarily exclude ordinary and customary meanings of the terms.

In this disclosure, continuously or continuous or continually can refer to without changing pressure, without interruption as a timeline, without any material intervening step, without changing conditions, immediately thereafter, as a next step, or without an intervening discrete physical or chemical structure between two structures other than the two structures in some embodiments and depending on the context.

Methods and systems in accordance with examples of the disclosure can be employed to extract, dry, or clean materials using supercritical solvents without active mechanical pumping of the extractant. A system that does not include mechanical pumps has the advantage of having no mechanically-active parts, which makes the design more durable and less prone to wear. Additionally, since no mechanically-active pumps are employed, overall sound levels during operation of the system are significantly reduced. The noise reduction may be particularly beneficial in the dry-cleaning industry and for industrial applications.

Methods in accordance with embodiments of the disclosure include use of a supercritical fluid. Exemplary methods include providing a substrate within a first vessel, providing a fluid (e.g., extractant) within the first vessel, forming a supercritical phase of the fluid within the first vessel, removing material (e.g., extract) from the substrate using the supercritical phase of the fluid, flowing a mixture of the fluid and the material to a separation vessel, reducing one or more of the temperature and the pressure within the separation vessel to below a critical point for the fluid to separate separated material from the fluid within the separation vessel, collecting the separated material in a collection vessel, and increasing pressure in the separation vessel to cause the fluid within the collection vessel to flow to the first vessel. As noted above, the method can be, and in at least some cases is, performed without the aid of a mechanical pump.

The fluid can include any suitable fluid that can become a supercritical fluid at desired operating conditions. Exemplary fluids include one or more of carbon dioxide, acetone, nitrous oxide, propane, ethanol, and nitrogen, with or without a cosolvent. By way of particular examples, the fluid is selected from the group consisting of one or more of carbon dioxide, carbon dioxide, acetone, nitrous oxide, propane, and ethanol, with or without a cosolvent.

The fluid can be initially provided to the first vessel as a liquid. The fluid can return to the first vessel from a separation vessel as a supercritical fluid.

Exemplary methods can include repeating the steps of providing the fluid, transforming the fluid, removing material, flowing the supercritical fluid and the material, reducing one or more of the temperature and pressure to below a critical point for the fluid, collecting the separated material, and increasing pressure in the separation vessel one or more times—e.g., to increase a yield of the (e.g., extraction) process.

Exemplary methods can further include operating one or more secondary vessels, wherein each secondary vessel receives a mixture of the fluid and the material, reduces one or more of the temperature and the pressure of the mixture to below a critical point for the fluid to form separated material within the secondary vessel, and increases a pressure within the secondary vessel to a pressure above a pressure within the first vessel. The use of the secondary vessels allows for continuous operation of the process and/or further refinement of the extracted material. Two or more secondary vessels and/or a separation vessel and one or more secondary vessels can be fluidly coupled in series and/or in parallel.

Exemplary methods can facilitate quiet and efficient extraction using supercritical solvents and allow for recovery of the extractant, the extract, and the leftover material. Applications of methods include the supercritical extraction of essential oils, or any chemical, from botanicals, such as but not limited to plants, seeds, flowers, vegetables, or bark; dry cleaning; drying of porous materials such as aerogels and composite aerogels, or any materials where its structure could collapse while drying due to capillary forces or other effects linked to phase transition; and the like.

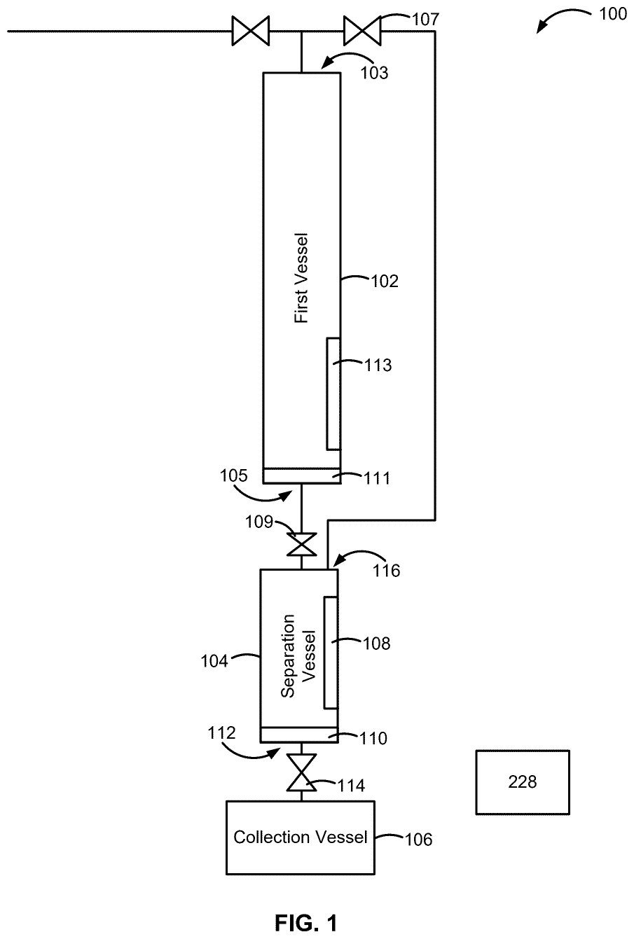

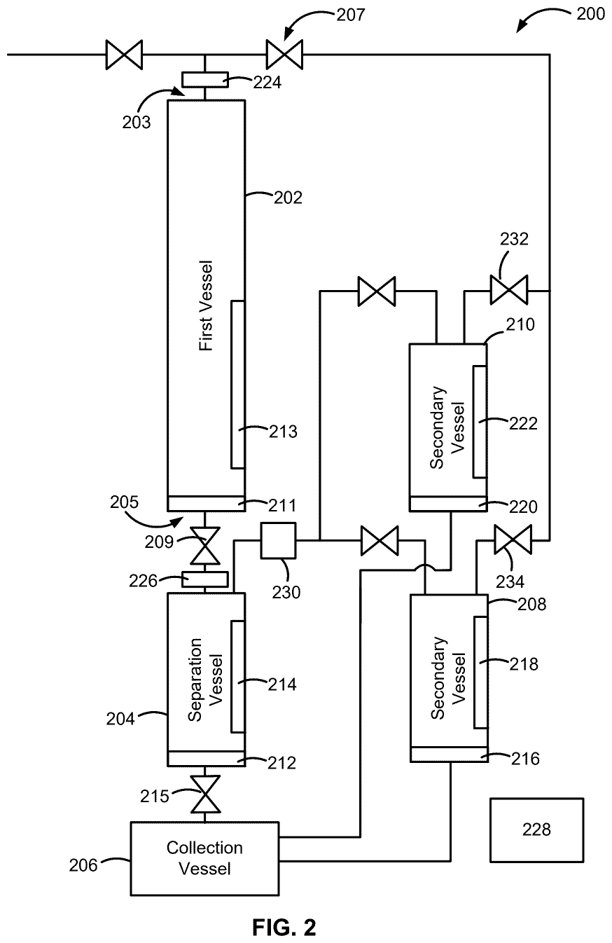

Turning now to the figures, FIG. 1 illustrates a system 100 in accordance with examples of the disclosure. System 100 includes a first vessel 102 comprising a first inlet port 103 to receive a fluid and a first outlet port 105 to expel the fluid, a first inlet valve 107 fluidly coupled to the first inlet port 103, a first outlet valve 109 fluidly coupled to the first outlet port 105; and a separation vessel 104 to receive a mixture from the first vessel 102, to separate the fluid from extracted material, and to increase a pressure within the separation vessel 104 to a pressure greater than a pressure in the first vessel 102. System 100 can also include a controller 228, described in more detail below in connection with FIG. 2.

First vessel 102 can be configured to withstand pressures and temperatures compatible with safe use of supercritical fluids (e.g., 3000 psi or higher and temperatures typically up to 100° C.). First vessel 102 can include or be proximate a heater (e.g., a resistive heater) 111 and/or a cooling device 113 (e.g., a chiller).

Similarly, separation vessel 104 can be configured to withstand pressures and temperatures compatible with safe use of supercritical fluids (e.g., 3000 psi or higher and temperatures typically up to 100° C.). Separation vessel 104 can include a port 112, which is coupled to a valve 114 between separation vessel 104 and a collection 106, and which allows draining of extracted compound to collection vessel 106. Separation vessel 104 can include or be proximate a heater 110 and/or a cooling device 108. A temperature of separation vessel 104 can be controlled using, for example, devices 108, 110, such as a closed-loop heater/chiller. Separation vessel 104 also includes an outlet 116 locate at or near a top of separation vessel 104. A flow of supercritical extractant from separation vessel 104 to first vessel 102 can be controlled using valves, such as valves 107, 109. As illustrates, outlet 116 is connected to first vessel 102 charging port 103. During operation, a pressure in the separation vessel 104 is increased (e.g., using heater 110) above a pressure within first vessel 102 to allow the transfer of the (e.g., supercritical) fluid from separation vessel 104. A pressure within separation vessel 104 can be reduced by opening a valve (e.g., valve 114) and/or cooling the vessel using cooling device 108.

FIG. 2 illustrates another system 200 in accordance with examples of the disclosure. System 200 includes a first vessel 202 comprising a first inlet port 203 to receive a fluid and a first outlet port 205 to expel the fluid, a first inlet valve 207 fluidly coupled to the first inlet port 203, a first outlet valve 209 fluidly coupled to the first outlet port 205, a separation vessel 204 to receive a mixture from the first vessel, to separate the fluid from extracted material, and to increase a pressure within the separation vessel to a pressure greater than a pressure in the first vessel, a collection vessel 206, and one or more secondary vessels 208, 210. First vessel 202, first inlet port 203, first outlet port 205, first inlet valve 207, first outlet valve 209, separation vessel 204, and collection vessel 206 can be as described above in connection with FIG. 1. First vessel 202 can include or be proximate heater 211 and/or cooling device 213, which can be as described above. System 200 can also include filters 224, 226.

Separation vessel 204 is used for the expansion of the supercritical fluid to below the fluid's critical point by means of controlling the pressure and/or temperature. Separation vessel 204 can be cooled using cooling device 214 to collect sub-critical extractant. Separation vessel 214 can be heated using heater 212. The heaters and cooling devices of system 200 can be as described above in connection with system 100.

Removal of the extracted substance from separation vessel 204 is achieved by operating the bottom valve 215. In one embodiment, the extracted substance is removed by means of opening the bottom valve during operation of the pumpless extractor. In another embodiment, the extracted substance is removed at the end of the operation cycle of the pumpless extractor. The flow from the separation vessel 204 to the secondary vessel 208, 210 is controlled using one or more valves. The secondary vessel 208, 210 can be cooled using cooling devices 216, 220 to collect sub-critical extractant.

In accordance with examples of the disclosure, system 200 further includes a controller 228 than can control one or more (e.g., all) heaters and cooling devices of system 200. Controller 228 can be coupled with the various power sources, heaters, cooling devices, robotics and gas flow controllers, or valves of the reactor, as will be appreciated by the skilled artisan. By way of example, controller 228 can be configured to control power to heaters 211, 212, 216, 220 and/or a temperature or flowrate of cooling fluid to cooling devices 213, 214, 218, 222. Controller 228 can be similarly configured to perform additional steps as described herein.

Controller 228 can include electronic circuitry and software to selectively operate valves, heaters, cooling devices and other components included in system 100 or 200. Such circuitry and components operate to introduce gases or liquids or to cause fluid to move within the system 100 or 200. Controller 1012 can control temperature and/or pressure within a vessel, and various other operations to provide proper operation of the system 100.

Controller 228 can include control software to electrically or pneumatically control valves to control flow of fluid into and out of the vessels. Controller 1012 can include modules, such as a software or hardware component, e.g., a FPGA or ASIC, which performs certain tasks. A module can advantageously be configured to reside on the addressable storage medium of the control system and be configured to execute one or more processes.

In one embodiment, during operation of system 200, a closed-loop recirculating heater/chiller (e.g., suitable for heater 212 and cooling device 214) controls (or is controlled by controller 228) a secondary vessel's temperature. In one embodiment, the temperature of the secondary vessel 208, 210 is controlled to achieve the liquefaction of the extractant in the secondary vessel 208, 210. In one embodiment, a heat exchanger 230 is placed in-line with the secondary vessel to increase the cooling and/or mass transfer efficiency. Next, the pressure and temperature inside the secondary vessel 208, 210 are increased to above the supercritical point of the extractant by means of heating said secondary vessel 208, 210. Next, the flow of supercritical extractant from the secondary vessel 208, 210 to first vessel 202 is achieved by operating one or more valves 232, 234, 207. Typically, the outlet of the secondary vessel 208, 210 is connected to the top of first vessel 202. Importantly, the pressure inside the secondary vessel 208, 210 should be higher than a pressure within first vessel 202 at this point to achieve mass-transfer and flow of the extractant to first vessel 202.

In one embodiment, continuous operation of system 200 is achieved by operating multiple secondary vessels 208, 210 sequentially. This embodies collection of the extractant in one or more cooled-down secondary vessels 208, 210, while at the same time, at least one other secondary vessels 208, 210 is heated up to above the supercritical temperature and pressure of the extractant and/or is charging first vessel 202 with supercritical extractant. Such heating and colling can be controlled by controller 228.

In one embodiment, a system or method described herein is used to extract molecules from plant-based products. For this, plant-based products such as orange peel, lavender, hops, or other products are loaded into the first vessel 102, 202. Next, the first vessel 102, 202 is filled, typically with liquid or supercritical extractant and the pressure and temperature inside the main vessel are controlled to be above the supercritical point of the extractant/fluid. Molecules are extracted by the supercritical extractant, which then is partially drained to the separation vessel 104, 204, where it undergoes a phase transition from a supercritical to a gaseous phase. The extracted molecules condensate during this process and typically are collected or drained to a collection vessel 106, 206. The gaseous extractant then flows to one or more of the secondary vessels 208, 210 where the fluid is liquified. Next, the pressure inside one or more of these secondary collection 208, 210 is increased to above first vessel pressure by action of heating said secondary vessel. Said method can be repeated to increase the efficiency and yield of the extraction. Finally, after gradual reduction of pressure inside first vessel 102, 202, leftover materials are retrieved from first vessel 102, 202.

In one embodiment, the pumpless extraction method is used to extract molecules from contaminated clothing. For this, the clothing is first vessel 102, 202. Next, the first vessel 102, 202 is filled, typically with liquid or supercritical extractant and the pressure and temperature inside the first vessel 102, 202 are controlled to be above the supercritical point of the extractant. The contamination molecules are extracted by the supercritical extractant, which is then partially drained to the separation vessel 104, 204, where it undergoes a phase transition from a supercritical to a gaseous phase. The extracted contamination molecules condensate during this process and typically are collected or drained at the bottom of the separation vessel 104, 204. The gaseous extractant then flows to one or more of the secondary vessels 208, 210 where it is liquified. Next, the pressure inside one or more of these secondary collection vessels 208, 210, is increased to above the pressure within first vessel 102, 202 by action of heating said secondary vessel 208, 210. The method can be repeated to completely remove all contamination molecules from the clothing. Finally, the cleaned clothing is retrieved from first vessel 102, 202 by the gradual reduction of pressure inside said main vessel.

In one embodiment, a system or method is used to dry porous materials, whose pores are filled with a liquid. For this, the porous material is loaded into the first vessel 102, 202, typically in the presence of a liquid to prevent damage to the porous materials as a result of capillary forces or other effects linked to phase transition. Next, first vessel 102, 202 is filled, typically with liquid or supercritical extractant and the pressure and temperature inside the first vessel are controlled (e.g., using heater 211) to be above the supercritical point of the extractant. The molecules inside the pores of the porous material are replaced by the extractant molecules. The extracted molecules are mixed with the extractant and are then partially drained to separation vessel 102, 204. The mixture undergoes a phase transition from a supercritical to a gaseous phase for the extractant while the extracted molecules condensate during this process and typically are collected or drained to collection vessel 106, 206. The gaseous extractant can then flow to one or more of the secondary vessels 208, 210, where the gas is liquified. Next, the pressure inside one or more of these secondary collection vessels 208, 210 is increased (e.g., using a heater 216, 220) to a pressure above a pressure within first vessel 202 by action of heating said secondary vessel. The method can be repeated to completely replace all liquid inside the porous material's pores with the supercritical extractant. Finally, the dried porous material is obtained by the phase transition of the supercritical extractant to the gaseous phase by means of decreasing the first vessel's pressure to below the supercritical point of said extractant, followed by the gradual reduction of pressure inside the first vessel.

The example embodiments of the disclosure described above do not limit the scope of the invention, since these embodiments are merely examples of the embodiments of the invention, which is defined by the appended claims and their legal equivalents. Any equivalent embodiments are intended to be within the scope of this invention. Indeed, various modifications of the disclosure, in addition to those shown and described herein, such as alternative useful combinations of the elements (e.g., steps) described, may become apparent to those skilled in the art from the description. For example, although illustrated with two secondary vessels, systems can include any suitable number of secondary vessels. Such modifications and embodiments are also intended to fall within the scope of the appended claims. Further, the claims provided below form part of the disclosure of the invention.

1. A method of using a supercritical fluid, the method comprising the steps of:
providing a substrate within a first vessel;
providing a fluid within the first vessel;
forming a supercritical phase of the fluid within the first vessel;
removing material from the substrate using the supercritical phase of the fluid;
flowing a mixture of the fluid and the material to a separation vessel;
reducing one or more of the temperature and the pressure within the separation vessel to below a critical point for the fluid to separate separated material from the fluid to form separated material within the separation vessel;
collecting the separated material in a collection vessel; and
increasing pressure in the separation vessel to cause the fluid within the collection vessel to flow to the first vessel.

2. The method of claim 1, wherein the steps are performed without a mechanical pump.

3. The method of claim 1, wherein the fluid comprises one or more of carbon dioxide, acetone, nitrous oxide, propane, ethanol, and nitrogen.

4. The method of claim 1, wherein the fluid is selected from the group consisting of one or more of carbon dioxide, acetone, nitrous oxide, propane, and ethanol.

5. The method of claim 1, wherein the fluid is supplied to the first vessel as a liquid.

6. The method of claim 1, further comprising repeating the steps of providing the fluid, forming the supercritical phase of the fluid, removing material, flowing the supercritical fluid and the material, reducing one or more of the temperature and pressure to below a critical point for the fluid, collecting the separated material, and increasing pressure in the separation vessel one or more times.

7. The method of claim 1, wherein the step of increasing pressure comprises heating the fluid.

8. The method of claim 1, further comprising operating one or more secondary vessels, such that each secondary vessel receives a mixture of the fluid and the material; and for each secondary vessel:
reducing one or more of the temperature and the pressure of the mixture to below a critical point for the fluid to form separated material within the secondary vessel; and
increasing a pressure within the secondary vessel to a pressure above a pressure within the first vessel.

9. The method of claim 8, wherein the one or more secondary vessels include two or more secondary vessels fluidly coupled in parallel.

10. The method of claim 8, wherein the one or more secondary vessels include two or more secondary vessels fluidly coupled in series.

11. The method of claim 10, wherein the one or more secondary vessels include two or more secondary vessels fluidly coupled in series and in parallel.

12. The method of claim 1, wherein the substrate comprises one or more of clothing, plant-based material, gel, or porous metamaterials.

13. The method of claim 1, further comprising a step of filtering the fluid prior to the fluid entering one or more of the first vessel and the separation vessel.

14. The method of claim 1, wherein one or more of the steps of flowing and collecting are gravity assisted.

15. A material cleaning process comprising the method of claim 1.

16. The method of claim 1, wherein the substrate comprises a gel.

17. The method of claim 1, wherein the material comprises one or more of an alcohol, an alkane, a ketone, a terpene, a cannabinoid, a fatty acid, an essential oil, or a fragrance.
